(19) United States
(12) Patent Application Publication
(10) Pub. No.: US 2004/0260579 A1
(43) Pub. Date: Dec. 23, 2004

(54) Technique for providing automobile insurance

(76) Inventor: Kimberly Irene Tremiti, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/465,732

(22) Filed: Jun. 19, 2003

(51) Int. Cl. G06F 17/60

(52) U.S. Cl. 705/4

(57) ABSTRACT

A technique for providing automobile insurance includes a number of steps. Initially, a term and a periodic monetary payment for an automobile insurance policy are set, based upon a rating applied to an entity. The rating is based, at least in part, upon an initial driving record associated with the entity and the periodic payment is paid by the entity to an insurer to maintain the automobile insurance in force. The insurer monitors the driving record associated with the entity during the term of the automobile insurance policy and provides a monetary payment to the entity upon expiration of the term, when the driving record associated with the entity during the term is above a minimum performance level.

### BACKGROUND OF THE INVENTION

The present invention is directed to a technique for providing insurance and, more specifically, to a technique for providing automobile insurance.

Traditionally, insurance companies have provided insurance to consumers through a network of agents, which have typically dealt with the insurance company through a managing general agency (MGA). In this manner, insurance companies have provided coverages, such as life, health, disability, major medical, critical illness, long-term care and property and casualty coverages to consumers. In a general situation, an entity, e.g., a consumer/business representative, desiring insurance will contact one or more agents to receive quotes on desired insurance coverages. With respect to automobile insurance, it has been common for an agent to gather relevant historical data from the entity, generally in a personal face-to-face interview with an individual.

Historically, the cost for providing automobile (i.e., motor vehicle) insurance has been determined by reviewing information provided by a given consumer during an application process, as well as by reviewing the consumer's public motor vehicle driving record, which is usually maintained by a government agency, e.g., the Secretary of State's Office in a given state. In determining the cost of automobile insurance for a particular consumer, an insurance company generally reviews many factors, such as an age, sex, marital status, location of residence and driving record of the consumer. Further, an insurance company will typically consider an age of a vehicle to be insured, a manufacturer and model of the vehicle to be insured, as well as a type of coverage sought by the consumer and liability limits and deductibles desired by the consumer. A typical automobile insurance policy may cover various categories, such as liability, uninsured motorist, comprehensive and collision.

Traditionally, current insurance rating systems also provide discounts and surcharges for some types of vehicle use, safety equipment installed on a vehicle and the type of driver. For example, insurance companies typically charge surcharges when an individual's vehicle is used for business use and provide discounts when a vehicle includes equipment, such as airbags, antilock brakes, alarm systems, and when the driver is a safe driver, i.e., accident-free for a period of time, and when the driver is a good student.

Other rating systems have been proposed in which a monitoring system is installed in a consumer's vehicle to evaluate how the consumer operates the vehicle. In such rating systems, the insurance rates are based upon the consumer's behavior when operating the automobile. Criteria that has been proposed for evaluating a driver when such a monitoring system is includes within the consumer's vehicle have included: a total driving time in minutes, the number of minutes driving in high and/or low risk locations, the number of minutes of driving at high and/or low risk times and driver behavior, such as seatbelts usage, turn signal usage and observation of speed limits and traffic control devices. Other criteria proposed for use in setting the rates for a particular consumer include the number of sudden braking situations and the number of sudden acceleration situations. Further criteria that have been proposed for setting a rate for a particular consumer include a location of the vehicle with respect to where it is parked at night and/or at work.

In such a system, surcharges, with respect to a policy, may be based upon excessive hard braking situations occurring in high risk locations and intermittent use of safety devices, such as seatbelts. Further, it has been proposed that discounts be provided when the individual consumer regularly selects low risk travel routes and regularly drives at low risk times. While insurance companies that implement such monitoring systems provide motivation to an individual consumer to develop safe driving habits, they do not, other than at the initial setting of a premium at the beginning of a term, necessarily motivate an individual consumer to develop and maintain safe driving habits.

What is needed is a technique that motivates an individual consumer to develop and maintain safe driving habits throughout a term of an individual automobile insurance policy.

### SUMMARY OF THE INVENTION

The present invention is generally directed to a method and system of providing automobile insurance. Initially, a term and a periodic monetary payment are set for an automobile insurance policy based upon a rating applied to an entity. The rating is based, at least in part, upon an initial driving record associated with the entity and the periodic monetary payment is paid by the entity to an insurer to maintain the automobile insurance policy in force. During the term of the automobile insurance policy, the driving record associated with the entity is monitored. Finally, upon expiration of the term, when the driving record associated with the entity during the term is above a minimum performance level, a monetary payment is provided from the insurer to the entity. It will be appreciated that the entity may be an individual and/or a business employing a plurality of individuals.

According to one embodiment of the present invention, the rating is based upon at least one of an age of an insured vehicle, a manufacturer and model of the vehicle, a value of the vehicle, an age of the individual, a sex of the individual, traffic violations associated with the individual, a number of accidents attributable to the individual, a place of residence of the individual, a marital status of the individual, a type of insurance coverage provided to the individual, an insurance deductible selected by the individual and a liability limitation selected by the individual.

According to another embodiment of the present invention, the rating may also be based upon, at least one of: whether the vehicle is used for business; whether the vehicle includes airbags; whether the vehicle includes anti-lock brakes; whether the vehicle includes theft control devices; and whether the individual is a good student. According to yet another embodiment of the present invention, the term may be one of 5, 10 and 15 years.

According to yet another embodiment of the present invention, the monetary payment is proportional to the total amount of money received by the insurer from the entity during the term. In still another embodiment, the monetary payment is capped at 50 or 70 percent of the total amount of money received by the insurer from the entity during the term. In another embodiment, the monetary payment is inversely proportional to claims paid by the insurer on behalf of the entity during the term of the automobile insurance policy.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is an exemplary drawing of a computer network including a computer system capable of implementing the present invention; and

FIG. 2 is a flow chart depicting an exemplary routine according to one embodiment of the present invention.

### DETAILED DESCRIPTION OF PREFERRED EMBODIMENTS

According to the present invention, a unique technique for providing automobile insurance is disclosed. In a conventional automobile insurance policy, an individual pays the premium for a term, for example, six months or one year, at which point at the end of the term the individual's premium may be raised or lowered depending upon the conduct of the individual during the previous term. However, the individual receives little incentive to maintain safe driving habits during the term, other than the fact that should the individual have a number of traffic citations and/or accidents the individual's insurance policy may be canceled and/or the insurance premium may be raised at the end of the term.

According to the present invention, an insurer provides a monetary payment to an entity, e.g., an individual or a business employing a plurality of individuals, upon expiration of a term when a driving record associated with the entity during the term is above a minimum performance level. Thus, the entity is, at least in part, self-insuring themselves and is receiving a monetary benefit from the insurer when an entity maintains their driving record above a minimum performance level, during the term.

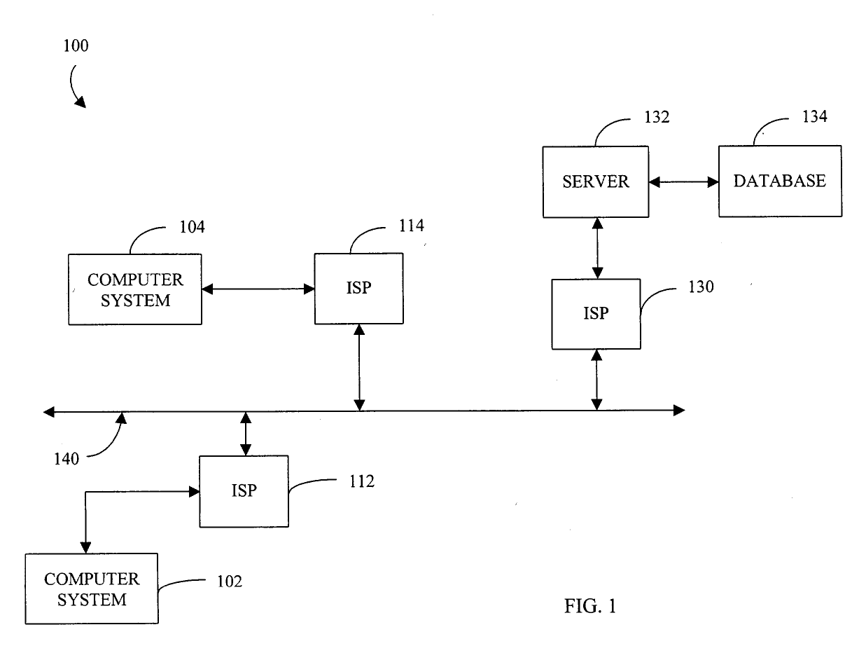

FIG. 1 depicts an exemplary computer network 100 that includes a computer system 102, which is coupled to an Internet service provider (ISP) 112, which couples the computer system 102 to the Internet 140. As is also shown in FIG. 1, an ISP 130 couples a server 132 to the Internet 140. The server 132, in this embodiment, represents an insurance company's Internet server computer system, which is coupled to a database 134 that includes information on various customers and applicants serviced by the insurance company. A computer system 104 represents another customer computer system, which is coupled to the Internet 140 via an ISP 114. The computer systems 102 and 104 may each include a processor, a display, an input device, a modem and a memory subsystem, which includes an application appropriate amount of volatile and non-volatile memory.

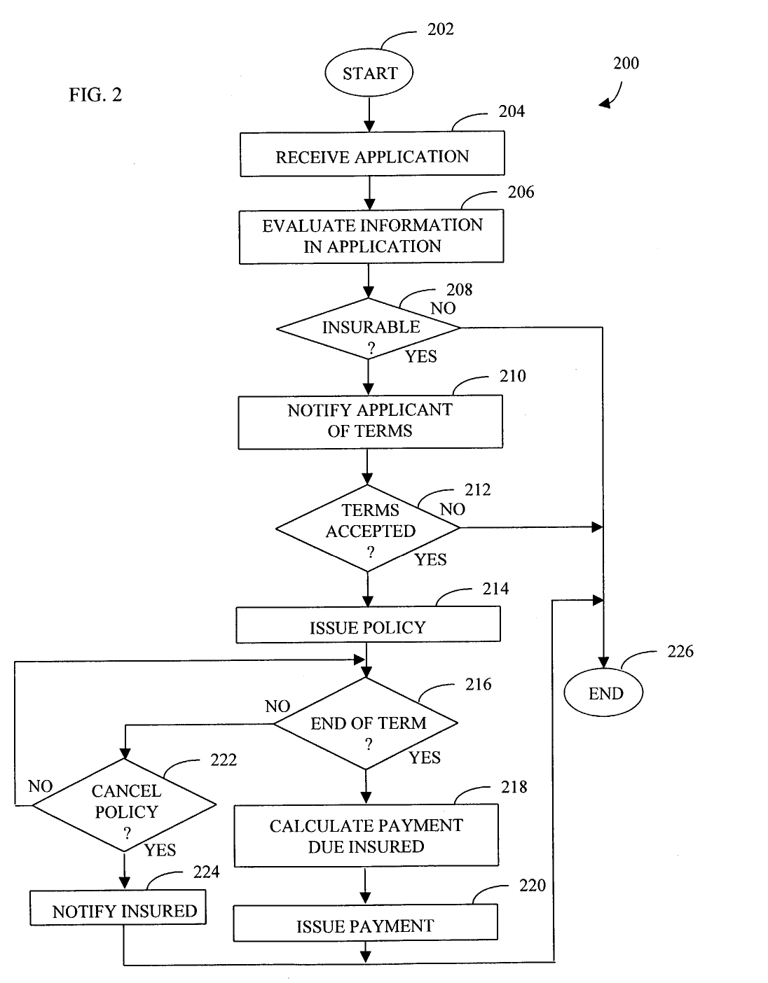

According to one embodiment of the present invention, a customer utilizing one of the computer systems 102 or 104 communicates with the server 132 through the ISP 112 or the ISP 114 and the ISP 130. As is discussed further with respect to FIG. 2, in this manner, a customer utilizing one of the computer systems 102 or 104 can communicate with the insurance company, via the server 132, and, for example, submit an application for insurance. In addition, the server 132 may communicate with a customer, via the computer systems 102 and 104, in the event that additional information is needed for the insurance application and/or to provide an insurance policy to the customer. In addition, the insurance company may provide a cancellation notice to a customer electronically, via the server 132 and the computer systems 102 and 104 and their associated ISPs.

With reference to FIG. 2, a routine 200 is depicted, which performs a number of functions according to various embodiments of the present invention. In step 202, the routine 200 is initiated, at which point control transfers to step 204. In step 204, the server 132 may electronically receive an application from a consumer. It should be appreciated that, upon login to the server 132, a consumer utilizing the computer system 102 may be presented with a form, for example, a hypertext transfer markup language (HTML) form to fill in to, for example, complete an application for automobile insurance. Upon receiving a completed application, the server 132 initiates a evaluation routine in step 206 that evaluates the information provided in the application. Next, in decision step 208, the server 132 determines whether, based upon the information provided by the consumer in the application, the insurance company desires to insure the applicant. If so, control transfers from step 208 to step 210. Otherwise, control transfers from step 208 to step 226, where the routine 200 terminates.

In step 210, the insurance company, via the server 132, notifies the consumer of the terms in which it will insure the consumer. That is, the insurance company, based upon the information received from the consumer, sets a term and a periodic monetary payment for providing an automobile insurance policy to the entity. As previously discussed, the rating may be based, at least in part, upon an initial driving record associated with the entity. Various criteria that may be included within the rating includes: an age of an insured vehicle; a manufacturer and model of the vehicle; a value of the vehicle; an age of the individual; a sex of the individual; traffic violations associated with the individual; a number of accidents attributable to the individual; a place of residence of the individual; a marital status of the individual; a type of insurance coverage provided to the individual; an insurance deductible selected by the individual; and liability limitations selected by the individual. Further, the rating may also be based, at least in part, upon: whether the vehicle is used for business, whether the vehicle includes airbags, whether the vehicle includes antilock brakes, whether the vehicle includes theft control devices and whether the individual is a good student.

Assuming that the consumer responds positively to the insurer in step 212, the insurer determines that the terms are accepted and control transfers to step 214. In step 212, when the consumer does not respond positively that the terms are accepted, control transfers to step 226. In step 214, based upon acceptance by the consumer of the insurer's terms, the insurer issues an automobile insurance policy to the consumer. The policy may be issued electronically and/or the server 132 may cause a copy of the policy to be printed to a printer (not shown) coupled to the server 132, at which point the printed policy is then mailed, via regular U.S. mail, to the consumer's address of record. Next, in decision step 216, the server 132 periodically determines whether the term of the policy for an individual consumer has ended. If so, control transfers to step 218, in which the server 132 executes a reward routine that calculates the payment due the insured. As a general rule, the payment refunded to the consumer is a percentage, e.g., fifty or seventy percent, of the total amount of money received by the insurer from the entity during the term. Alternatively, the payment refunded may be a fixed amount based on the length (e.g., five, ten or fifteen years) of the term.

Next, in step 220, the server 132 issues payment to the consumer. The payment may be issued by the server 132 by, for example, electronically crediting a particular amount to a financial account of the consumer or the server 132 may initiate printing of a check, at which point the check is mailed to the consumer's address of record. Upon termination of step 220, control transfers to step 226. In step 216, when the end of the term is not detected, control transfers to decision step 222. In decision step 222, the server 132, by executing a cancellation routine that evaluates information on an individual consumer located within a database 134, determines whether circumstances have changed such that the automobile insurance policy associated with a particular consumer should be canceled. That is, when a driving record associated with the entity is below an acceptable risk level, the server 132 initiates cancellation of the automobile policy associated with the entity. When the server 132 determines that the driving record associated with the entity is above an acceptable risk level, control transfers to step 216. The risk level may be set based upon various factors, e.g., a number of accidents, and/or a number of citations and/or a claim or claims exceeding a specific dollar amount. When the server 132 determines that the driving record of the entity is below an acceptable risk level, control transfers to step 224, where the server 132 notifies the insured, e.g., via regular U.S. mail and/or electronic mail (email), that the insured's insurance policy is being canceled, at which point, control transfers to step 226.

Accordingly, a system and method have been described herein, which essentially allows an insured to become somewhat self-insured, in that that they are provided a monetary payment from an insurer upon expiration of a term when the driving record associated with the entity during the term is above a minimum performance level. Such a technique for providing automobile insurance is also advantageous for an insurer, in that it minimizes losses incurred by the insurer at the same time allowing the insurer to utilize the premiums received from an insured entity, during the term of the automobile insurance policy. As with traditional insurance companies, this allows the insurer to invest the periodic monetary payment received from the entity in various investment vehicles, such as bonds, stocks and/or certificates of deposit.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed:

1. A method of providing automobile insurance, comprising the steps of:
setting a term and a periodic monetary payment for an automobile insurance policy based upon a rating applied to an entity, wherein the rating is based at least in part upon an initial driving record associated with the entity, and wherein the periodic monetary payment is paid by the entity to an insurer to maintain the automobile insurance policy in force;
monitoring a driving record associated with the entity during the term of the automobile insurance policy; and
providing a monetary payment from the insurer to the entity upon expiration of the term when the driving record associated with the entity during the term is above a minimum performance level.

2. The method of claim 1, wherein the entity is an individual.

3. The method of claim 2, wherein the rating is based upon at least one of an age of an insured vehicle, a manufacturer and model of the vehicle, a value of the vehicle, an age of the individual, a sex of the individual, traffic violations associated with the individual, a number of accidents attributable to the individual, a place of residence of the individual, a marital status of the individual, a type of insurance coverage provided to the individual, an insurance deductible selected by the individual and a liability limitation selected by the individual.

4. The method of claim 3, wherein the rating is also based upon at least one of whether the vehicle is used for business, whether the vehicle includes airbags, whether the vehicle includes antilock brakes, whether the vehicle includes theft control devices and whether the individual is a good student.

5. The method of claim 1, wherein the entity is a business.

6. The method of claim 1, wherein the term is one of five, ten and fifteen years.

7. The method of claim 1, wherein the monetary payment is proportional to the total amount of money received by the insurer from the entity during the term.

8. The method of claim 7, wherein the monetary payment is capped at fifty percent of the total amount of money received by the insurer from the entity during the term.

9. The method of claim 7, wherein the monetary payment is capped at seventy percent of the total amount of money received by the insurer from the entity during the term.

10. The method of claim 7, wherein the monetary payment is inversely proportional to claims paid by the insurer on behalf of the entity during the term of the automobile insurance policy.

11. The method of claim 1, further including the step of:
canceling the automobile insurance policy when the driving record associated with the entity is below an acceptable risk level.

12. A method of providing automobile insurance, comprising the steps of:
setting a term and a periodic monetary payment for an automobile insurance policy based upon a rating applied to an entity, wherein the rating is based at least in part upon an initial driving record associated with the entity, and wherein the periodic monetary payment is paid by the entity to an insurer to maintain the automobile insurance policy in force;
monitoring a driving record associated with the entity during the term of the automobile insurance policy; and
providing a monetary payment from the insurer to the entity upon expiration of the term when the driving record associated with the entity during the term is above a minimum performance level, wherein the monetary payment is inversely proportional to claims paid by the insurer on behalf of the entity during the term of the automobile insurance policy.

13. The method of claim 12, wherein the entity is an individual.

14. The method of claim 13, wherein the rating is based upon at least one of an age of an insured vehicle, a manufacturer and model of the vehicle, a value of the vehicle, an age of the individual, a sex of the individual, traffic violations associated with the individual, a number of accidents attributable to the individual, a place of residence of the individual, a marital status of the individual, a type of insurance coverage provided to the individual, an insurance deductible selected by the individual and a liability limitation selected by the individual.

15. The method of claim 14, wherein the rating is also based upon at least one of whether the vehicle is used for business, whether the vehicle includes airbags, whether the vehicle includes antilock brakes, whether the vehicle includes theft control devices and whether the individual is a good student.

16. The method of claim 12, wherein the entity is a business.

17. The method of claim 12, wherein the term is one of five, ten and fifteen years.

18. The method of claim 12, wherein the monetary payment is proportional to the total amount of money received by the insurer from the entity during the term.

19. The method of claim 18, wherein the monetary payment is capped at fifty percent of the total amount of money received by the insurer from the entity during the term.

20. The method of claim 18, wherein the monetary payment is capped at seventy percent of the total amount of money received by the insurer from the entity during the term.

21. The method of claim 12, further including the step of:
canceling the automobile insurance policy when the driving record associated with the entity is below an acceptable risk level.

22. A system for providing automobile insurance, the system comprising:
a processor;
a memory subsystem coupled to the processor, the memory subsystem storing code that when executed by the processor causes the processor to perform the steps of:
setting a term and a periodic monetary payment for an automobile insurance policy based upon a rating applied to an entity, wherein the rating is based at least in part upon an initial driving record associated with the entity, and wherein the periodic monetary payment is paid by the entity to an insurer to maintain the automobile insurance policy in force;
monitoring a driving record associated with the entity during the term of the automobile insurance policy; and
providing a monetary payment from the insurer to the entity upon expiration of the term when the driving record associated with the entity during the term is above a minimum performance level, wherein the entity is at least one of an individual and a business, and wherein the rating is based upon at least one of an age of an insured vehicle, a manufacturer and model of the vehicle, a value of the vehicle, an age of the individual, a sex of the individual, traffic violations associated with the individual, a number of accidents attributable to the individual, a place of residence of the individual, a marital status of the individual, a type of insurance coverage provided to the individual, an insurance deductible selected by the individual and a liability limitation selected by the individual.

23. The system of claim 22, wherein the rating is also based upon at least one of whether the vehicle is used for business, whether the vehicle includes airbags, whether the vehicle includes antilock brakes, whether the vehicle includes theft control devices and whether the individual is a good student.

24. The system of claim 22, wherein the term is one of five, ten and fifteen years.

25. The system of claim 22, wherein the monetary payment is proportional to the total amount of money received by the insurer from the entity during the term.

26. The system of claim 25, wherein the monetary payment is capped at fifty percent of the total amount of money received by the insurer from the entity during the term.

27. The system of claim 25, wherein the monetary payment is capped at seventy percent of the total amount of money received by the insurer from the entity during the term.

28. The system of claim 25, wherein the monetary payment is inversely proportional to claims paid by the insurer on behalf of the entity during the term of the automobile insurance policy.

29. The system of claim 22, wherein the code when executed by the processor causes the processor to perform the additional step of:
canceling the automobile insurance policy when the driving record associated with the entity is below an acceptable risk level.
